(19) United States
(12) Patent Application Publication
(10) Pub. No.: US 2013/0103410 A1
(43) Pub. Date: Apr. 25, 2013

(54) SYSTEM AND METHOD FOR ENABLING OPERATION OF A MEDICAL DEVICE

(71) Applicants: Clint Carnell, Park City, UT (US); Jeff Nardoci, Danville, CA (US)

(72) Inventors: Clint Carnell, Park City, UT (US); Jeff Nardoci, Danville, CA (US)

(73) Assignee: SOLTA MEDICAL, INC., Hayward, CA (US)

(21) Appl. No.: 13/277,903

(22) Filed: Oct. 20, 2011

(51) Int. Cl. G06Q 50/22; G06F 17/00

(52) U.S. Cl. 705/2; 235/375

(57) ABSTRACT

Systems and methods of enabling a medical device for operation and billing a medical procedure performed with a medical device. A medical procedure barcode is purchased through a user interface executing on a server. The server updates a medical procedure database to indicate that the purchased medical procedure barcode is valid. The medical procedure barcode is read by a barcode reader, and the medical procedure database is queried to determine if the read medical procedure barcode is valid. A medical device is enabled for use by a medical procedure service provider if the medical procedure barcode is valid, such that the medical procedure may be performed using the enabled medical device. The medical procedure database is updated to indicate that the medical procedure barcode has been redeemed by the medical procedure service provider. The server transmits payments to the medical procedure service provider for the redeemed medical procedure barcode.

### BACKGROUND

The invention relates generally to medical procedures performed with a medical device, and in particular, to a system and method for enabling a medical device for use in a medical procedure.

Many common medical procedures use medical devices that in turn use one-time use treatment tips to perform a desired medical procedure. In general, these treatment tips are limited to one use to increase patient safety, sanitization, reliability of the medical device, and other such reasons. Similarly, some medical devices require purchase of a treatment tip for each procedure as a revenue source for a medical device provider to, among other reasons, reduce the initial equipment cost.

Improved systems and methods for performing a medical procedure with a medical device requiring one-time use treatment tips are needed.

### BRIEF SUMMARY

In general, the present invention is directed to an apparatus and method for facilitating the billing and performance of medical procedures using a medical device that requires a single use medical attachment. More particularly, the system and method are directed to collecting payment for a medical procedure using a medical device, validating use of a single use treatment tip with the medical device, enabling the medical device for performing the medical procedure with the validated treatment tip over a communication network, and/or automating payment to a medical service provider performing the medical procedure through the use of a medical procedure barcode. The system and method addresses at least some of the problems encountered with conventional medical devices as explained above.

In one embodiment of the invention, a medical device includes a transceiver configured to be connected to a communication network, a memory, and a processor. The processor of the medical device is configured to receive medical procedure barcode data, where the medical procedure barcode data is associated with a medical procedure barcode. The processor may transmit the medical procedure barcode data using the transceiver over a connected communication network. The processor may receive validation data from the communication network using the transceiver, where the validation data may indicate whether the medical procedure barcode associated with the medical procedure barcode data is valid or not valid. The processor of the medical device may analyze the validation data to determine whether the medical procedure barcode is valid, and in response to determining that the medical procedure barcode is valid, the processor of the medical device may set the medical device to an enabled state. As such, in this embodiment, the medical device may be enabled to perform a medical procedure when the medical device receives medical procedure barcode data associated with a valid medical procedure barcode. Alternatively, if the processor determines that the medical procedure barcode is not valid, the processor may cause the medical device to generate one or more indications for an operator of the device to inform the operator that the medical procedure barcode associated with the medical procedure barcode data is not valid.

In another embodiment of the invention, a method for performing a medical procedure with a medical device at a medical service provider includes receiving medical procedure barcode data associated with a medical procedure barcode at the medical device. The medical device transmits the medical procedure barcode data over a communication network, and the medical device receives validation data from the communication network in response to the transmitted medical procedure barcode data. The received validation data indicates if the medical procedure barcode associated with the medical procedure barcode data is valid or invalid. The medical device analyzes the validation data to determine whether the medical procedure barcode is valid, and in response to determining that the medical procedure barcode is valid, the medical devices is enabled for operation, such that the medical device may be used to perform the medical procedure, and thereby redeeming the medical procedure barcode associated with the medical procedure barcode data at the medical service provider.

### BRIEF DESCRIPTION OF THE SEVERAL VIEWS OF THE DRAWINGS

The accompanying drawings, which are incorporated in and constitute a part of this specification, illustrate various embodiments of the invention, and together with a general description of the invention given above and the detailed description of the embodiments given below, serve to explain the embodiments of the invention.

FIG. 1 is a schematic perspective view of a medical device, server, and computer according to some embodiments of the invention.

FIG. 2 is a schematic view of a medical device, server, and computer consistent with embodiments shown in FIG. 1.

FIG. 3 is a flowchart illustrating a sequence of operations that may be executed by a medical device consistent with some embodiments of the invention.

FIG. 4 is a flowchart illustrating a sequence of operations that may be executed by a computer and/or server consistent with some embodiments of the invention.

FIG. 5 is a flowchart illustrating a sequence of operations that may be executed by a computer and/or server consistent with some embodiments of the invention.

### DETAILED DESCRIPTION

Generally, embodiments of the invention are directed to a system and method for collecting payment for a medical procedure using a medical device, validating use of the medical device, enabling the medical device over a communication network to perform the medical procedure, and/or automating payment to a medical service provider for performance of the medical procedure with the medical device through the use of medical procedure barcodes and a medical procedure database.

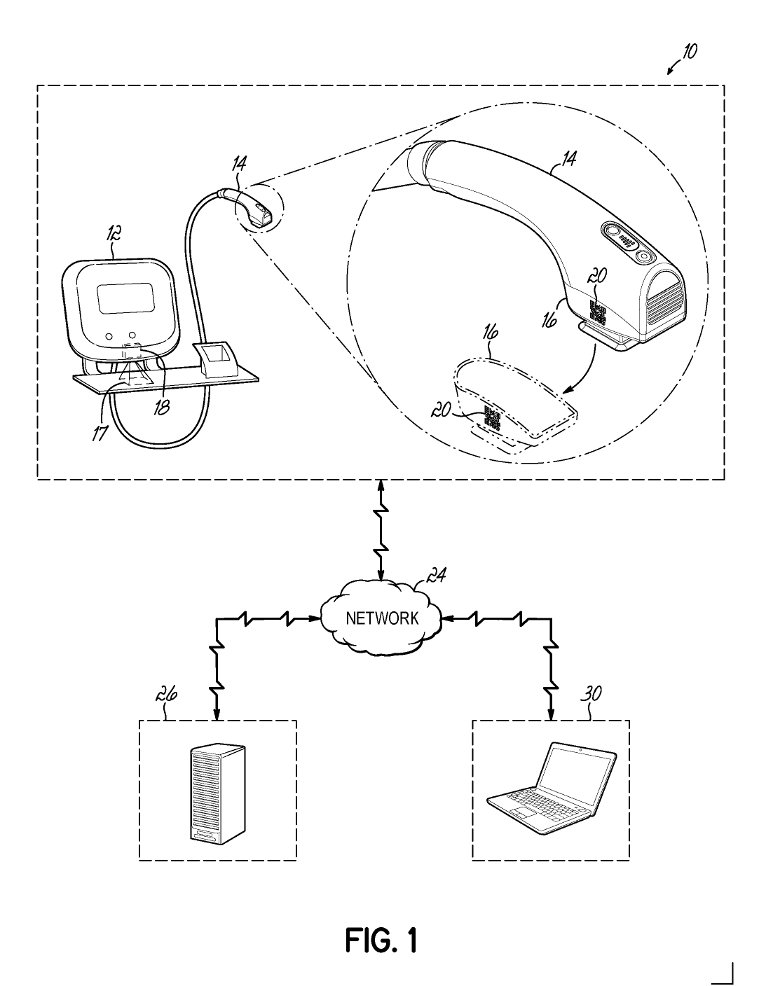

With reference to FIG. 1 and in accordance with an embodiment of the invention, a medical device 10 for use in performing a medical procedure by a medical service provider is illustrated. The medical device 10 includes a treatment system 12, a handpiece 14 and a treatment tip 16 configured to be removably coupled with the handpiece 14. When treatment tip 16 is coupled with the handpiece 14, the medical device 10 may be used in to perform a medical procedure.

The treatment system 12 and/or the handpiece 14 may include an electromagnetic radiation (EMR) source configured to generate electromagnetic radiation having properties that are useful for performing a medical procedure comprising a dermatological or cosmetic tissue treatment. The electromagnetic radiation is launched toward the tissue through the treatment tip 16. For example, the electromagnetic radiation may originate from a flash lamp, or a similar light source, having one or more bulbs or lamps configured to generate broadband light in either pulsed or continuous operation modes. As another example, the electromagnetic radiation may originate from a laser, such as a diode laser housed inside the handpiece 14.

The treatment tip 16 may include a medical procedure barcode 20 that is associated with a medical procedure. The barcode 20 may be comprised of machine-readable markings that, in a representative embodiment, comprise a one-dimensional or two-dimensional format containing a light background and dark informational elements organized in a pattern on the light background. In one embodiment, the medical procedure barcode 20 may be an Aztec two-dimensional barcode that is encoded with a random 35-character string (UUID) using an error correction level of 23.

The medical device 10 may further include a barcode scanner or reader 18 for reading the medical procedure barcode 20, where the medical procedure barcode 20 includes data associated with the medical procedure to be performed. The barcode reader 18 may be equipped with a light source, electronics, and other components that cooperate for reading, imaging, or scanning the medical procedure barcode 20 and then translating the resulting medical procedure barcode data into a form that can be communicated to a computer processor. The barcode reader 18 may comprise a light source and a photodiode, a scanned laser beam and a photodiode, a CCD reader, a camera-based reader, etc. In the representative embodiment, the barcode reader 18 is directly coupled with treatment system 12 and thereby integrated into the construction of the treatment system 12. The barcode 20 is placed at a stationary position in or moved through a field of vision 17. For example, if the barcode 20 is directly disposed on the treatment tip 16, the treatment tip 16 can be moved through the field of vision 17. In an alternative embodiment, barcode reader 18 may be attached to a computing device in communication with treatment system 12, and thereby indirectly coupled with the treatment system 12 of the medical device 10. The barcode reader 18 may also be a separate device that is indirectly coupled by a cable with the medical device 10.

As shown in the representative embodiment of FIG. 1, the medical procedure barcode 20 may be directly printed on the treatment tip 16 or may be printed on a label that is applied by, for example, adhesive bonding to the treatment tip 16. Alternatively, the medical procedure barcode 20 may be printed on other types of surfaces, displayed virtually on a screen of an electronic device, or displayed for reading by other methods as understood by a person having ordinary skill in the art. For example, the medical procedure barcode 20 may be printed onto the surface of a substrate, such as a paper substrate or label stock, and therefore not coupled either directly or indirectly with the treatment tip 16.

Medical device 10 may be in communication with one or more computing devices, as shown in FIG. 1. Medical device 10 may be connected to communication network 24, such that data may be transmitted to and received from remote computing devices over the communication network 24. As shown, server 26 may be in communication with the medical device 10 over communication network 24, where server 26 may be connected to and configured to access a medical procedure database. In addition, server 26 may be configured to collect a payment for a medical procedure, store data indicating whether a medical procedure barcode 20 is valid, transmit data to the medical device 10 indicating whether a medical procedure barcode 20 is valid, enable a medical device 10 over the communication network 24, and/or transmit payment to a medical procedure service provider for a performed medical procedure.

In some embodiments, additional computing devices such as computer 30 may be in communication with medical device 10 and/or server 26 over communication network 24. As such, in these embodiments, computer 30 may be utilized to purchase a medical procedure barcode 20 for use in a medical procedure, where server 26 may thereby cause the medical device 10 to be enabled for operation when the purchased medical procedure barcode 20 is read by the barcode reader 18 of the medical device 10. As such, patients desiring a medical procedure and/or medical service providers preparing to perform a medical procedure using the medical device 10 may purchase an enabling medical procedure barcode over communication network 24.

In some embodiments, an automated payment interface may be executing on server 26, such that a patient and/or medical service provider may access the automated payment interface over communication network 24 using the computer 30. The automated payment interface may be a secure web page, a secure server portal, and/or other such remote interface configured to collect payment for a medical procedure. In addition, the automated payment interface executing on one or more servers 26 may generate and/or update the medical procedure database to indicate that the purchased medical procedure barcode as valid.

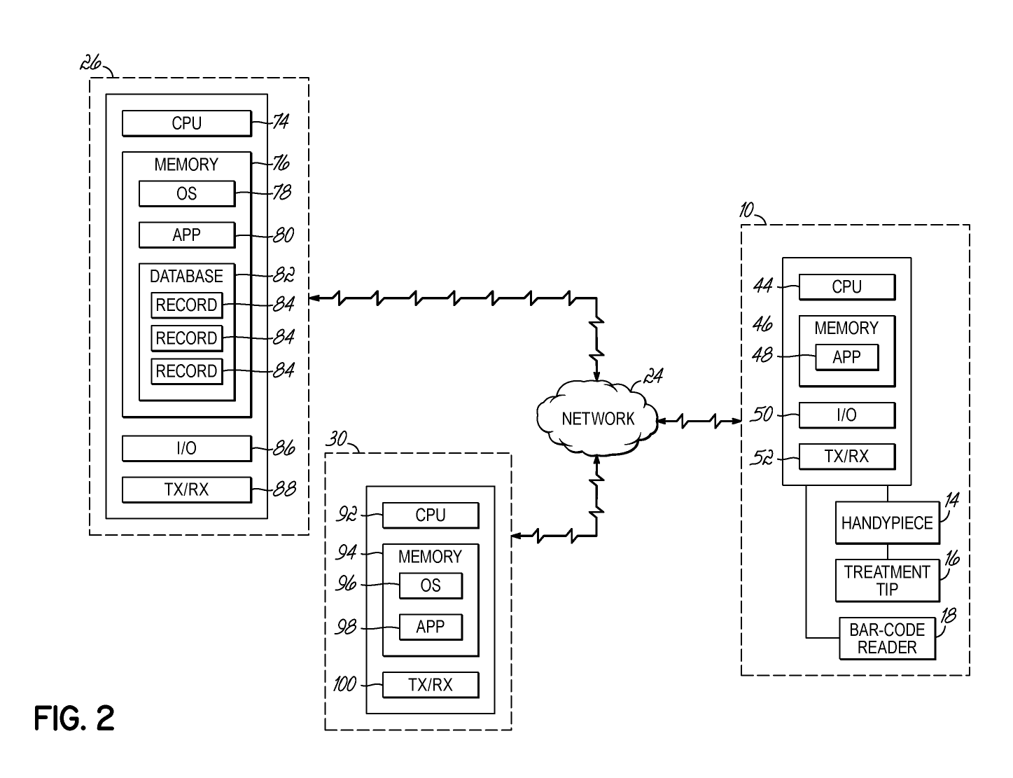

FIG. 2 illustrates a schematic view of an exemplary medical device 10 consistent with some embodiments of the invention including the medical system of FIG. 1. As shown, the medical device 10 includes a processor (“CPU”) 44 and a memory 46, where the memory 46 includes an application 48 stored thereon. The application 48 includes sequences of operations that may be executed by the processor 46 to cause the processor 46 to perform the steps necessary to execute steps, operations, or elements embodying the various aspects of the invention. As such, processors consistent with the invention may be configured to perform operations, elements, and/or steps, and those skilled in the art will appreciate that the processors may be general purpose processors and/or special purpose processors configured to perform the necessary operations by executing the sequences of operations provided by one or more applications consistent with embodiments of the invention.

In addition, the medical device 10 may include input/output (“I/O) interface 50, where the I/O interface 50 may transmit and receive data to and from the processor 44 to and from external devices, including for example a monitor, a keyboard, a barcode reader, a computer mouse, a removably coupled treatment tip, and/or other such like devices. Medical device 10 may include a transceiver (“TX/RX”) 52, where the transceiver 52 may be connected to the communication network 24, such that the processor 44 may transmit and receive data to and from the communication network 24 using transceiver 52. As discussed above, with respect to FIG. 1, the medical device 10 may include the treatment tip 16, configured to be removably coupled with the handpiece 14 of the medical device 12. In addition, the barcode reader 18 may be associated with the medical device for reading the medical procedure barcode 20.

In addition, the server 26 may be connected over the communication network 24 to the medical device as shown. The server 26 includes a processor 74 and a memory 76. The memory 76 may include an operating system 78 and application 80, where the operating system 78 may include sequences of operations executable by the processor 74 to cause the processor 74 to perform steps, operations, and/or elements consistent with embodiments of the invention. In addition, the memory 76 may include a database 82 stored therein, where the database 82 may comprise a medical procedure database consistent with embodiments of the invention. As shown, database 82 may include records 84, where the records 84 may include data indicating whether one or more medical procedure barcodes are valid. The memory 76 also includes a database management system (DBMS) in the form of a computer program that, when executing as instructions on the processor 74, is used to access the information or data stored in the medical procedure records of the database 82. Furthermore, the server 26 includes an I/O interface 86 and a transceiver 88 connected to communication network 24.

In some embodiments, the application 80 may be configured to cause the processor 74 to execute an automated payment interface consistent with embodiments of the invention, such that a remote computer may connect to server 26 and interface with application 80 to submit a payment for a medical procedure.

Additionally, the computer 30 may be in communication with medical system 10 over communication network 24, where the computer 30 includes a processor 92, a memory 94 in turn including an operating system 96 and an application 98, and a transceiver 100 connected to the communication network 24.

While a medical device consistent with some embodiments of the invention has and hereinafter will be described with respect to a server, those skilled in the art will appreciate that a server may generally comprise one or more computing devices, each having one or more processors and one or more memory structures. Moreover, as known in the relevant field, memory of a server may be connected remotely through a communication network, and as such, memory of a server may be housed in a remote device in communication with a processor of a server, and/or an interconnected computing device. Moreover memory as included in a server system may comprise one or more individual storage units configured to operate as one or more memory locations. As such, those skilled in the art will recognize that the invention contemplates all types of computing devices, including computing devices configured with processors, memory, and/or storage devices regardless of whether those hardware resources are located locally or distributed remotely.

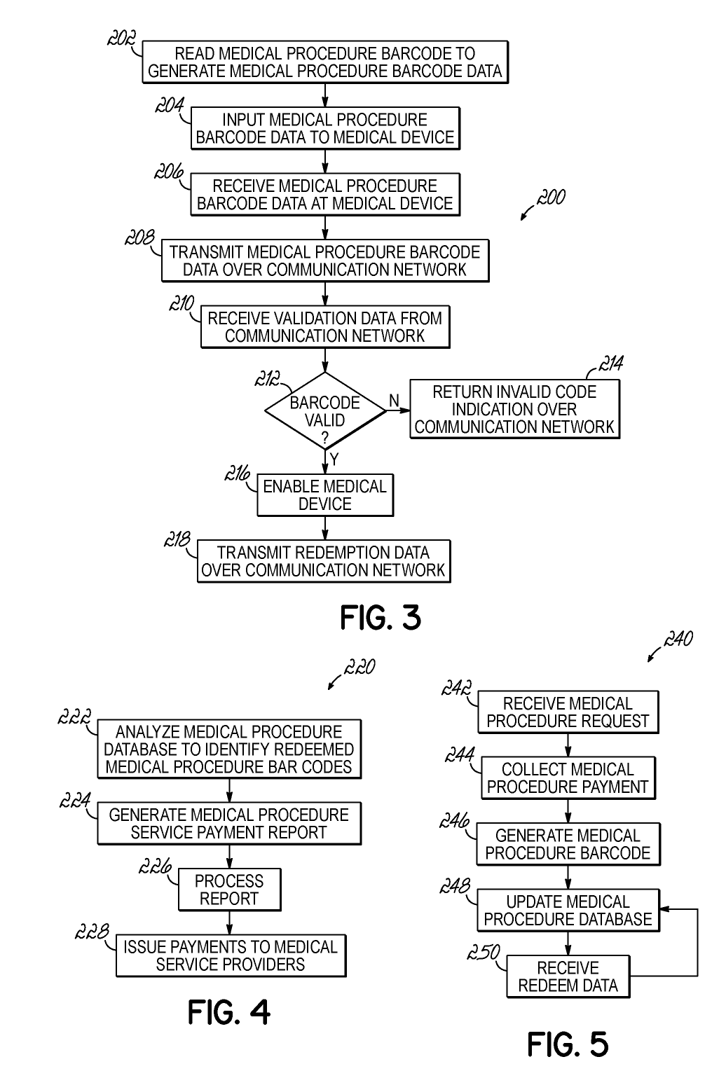

With reference to FIG. 3, flowchart 200 is provided which illustrates a sequence of operations that may be executed by a medical device consistent with embodiments of the invention to enable the medical device used by a medical service provider to perform a medical procedure. A medical procedure barcode, is read using a barcode reader at a medical procedure service provider to generate medical procedure barcode data associated with the medical procedure barcode (block 202). The medical procedure barcode data is input to the medical device (block 204). The medical device receives the medical procedure barcode data from the barcode reader (block 206). In some embodiments, the medical device may be in communication with the barcode reader, such that the barcode reader may input the medical procedure barcode data to the processor via an I/O interface, and the processor of the medical device may thereby receive the medical barcode data from the barcode reader. Alternatively, a computer in communication with the medical device may be in communication with the barcode reader, such that a processor of the computer may receive the medical procedure barcode data from the medical barcode reader, and the computer may transmit the medical procedure barcode data to the medical device. While systems and methods consistent with the invention have been described as receiving barcode data from a barcode reader, those skilled in the art will recognize that a barcode generally represents data in a format that facilitates scanning by a barcode reader, and the data transmitted from a barcode reader is generally the data represented by the barcode, and not necessarily an image of the barcode. As such, embodiments consistent with the invention may receive the data represented by a barcode from the barcode reader, where the received data may be in a format (e.g., a digital format) recognized by a processor consistent with embodiments of the invention.

The medical device transmits the medical procedure barcode data over a connected communication network (block 208). In some embodiments, the medical procedure barcode data may be compressed and/or converted to another digital format prior to transmission to facilitate secure communication and/or to facilitate increased transmission rate. In response to transmitting the medical procedure barcode data over the communication network, the medical device receives validation data from the communication network (block 210). The validation data may indicate whether the medical procedure bar code associated with the medical procedure barcode data is valid, i.e., the validation data may indicate whether the medical procedure barcode read by the barcode reader is valid. The medical device analyzes the validation data to determine whether the medical procedure barcode is valid (block 212).

In response to determining that the medical procedure barcode is not valid, the processor of the medical device may generate an invalid code indication (block 214). In some embodiments, the processor of the medical device may cause an indication to be displayed visually on a screen of the medical device and/or the processor may cause an indication to be reproduced audibly on a speaker associated with the medical device, such that an operator of the medical device will be notified that the medical procedure barcode read by the barcode reader is not valid, and that the medical procedure may not be performed without a valid medical procedure barcode being first read by the barcode reader and validated by the medical device.

In response to determining that the medical procedure barcode is valid, the processor of the medical device may set the medical device to an enabled state, such that the medical device may perform the medical operation (block 216).

In some embodiments, in response to enabling the medical device, the medical device transmits redeem data which indicates that the medical procedure barcode has been redeemed and also indicating the medical service provider at which the medical procedure barcode was redeemed (i.e., the redeem data includes a unique identifier associated with the medical service provider which identifies the medical service provider) (block 218). The enabled medical device may then be used to generate electromagnetic radiation for the performance of the medical procedure.

As such, in some embodiments, a medical procedure barcode is read by a barcode reader and the medical device is enabled to perform the medical procedure if the medical procedure barcode is determined to be valid. In these embodiments, a medical procedure database may include data indicating whether the medical procedure barcode is valid, and the medical procedure database may be queried to retrieve data indicating whether the medical procedure barcode is valid.

FIG. 4 provides flowchart 220 which illustrates a sequence of operations consistent with embodiments of the invention which may be executed by a processor of a server to automate payments to medical service providers performing medical procedures utilizing medical devices consistent with embodiments of the invention. A server consistent with embodiments of the invention analyzes a medical procedure database to identify medical procedure barcodes that have been redeemed (block 222). The server generates a medical procedure service payment report, where the report includes data indicating one or more medical procedure barcodes that have been redeemed, as indicated in the medical procedure database (block 224). In some embodiments, the report may be used to manually process payments to each service provider at which a medical procedure barcode was redeemed. In other embodiments, payment for the redeemed medical procedure barcodes may be automated using the server or other connected computing device. As such, in some embodiments, the report may be processed by the server such that payment information is loaded into an electronic payment system (block 226). The electronic payment system may be executed on the server or other such computing device, and the electronic payment system may issues a medical procedure service payment to each medical service provider at which a medical procedure barcode was redeemed (block 228).

FIG. 5 provides flowchart 240 which illustrates a sequence of operations consistent with embodiments of the invention which may be executed by a processor of a server to collect payment for a medical procedure and update a medical procedure database after redemption of a medical procedure barcode. A server consistent with embodiments of the invention may receive a medical procedure request (block 242). In some embodiments, the medical procedure request may be generated by a medical procedure customer through an internet based user interface configured to permit customers to purchase medical procedures. In some embodiments, the medical procedure request may be generated by a medical procedure service provider through a user interface configured to permit medical service providers to purchase medical device enabling medical procedure barcodes for performing a medical procedure.

In response to receiving the medical procedure request, the server collects a payment based on the received medical procedure request (block 244). In some embodiments, an Internet-based user interface may allow a user making the medical procedure request to make a payment, such that the server and executing interface may collect payment for the medical procedure request. In one aspect of some embodiments, the server may generate a medical procedure barcode based at least in part on the received medical procedure request (block 246). The server updates the medical procedure database based at least in part on the generated medical procedure barcode, where the medical procedure database includes data indicating that the medical procedure barcode is valid (block 248). The medical procedure database may be stored in a memory accessible by a server of the medical system. As such, in these embodiments, payment for a medical procedure is collected, a medical procedure barcode is generated, and the medical procedure database is updated to indicate that the generated medical procedure barcode is valid. In some embodiments, the server may receive redeem data indicating that a medical procedure barcode has been redeemed and also indicating the medical service provider at which the medical procedure barcode was redeemed (block 250). In these embodiments, in response to receiving the redeem data, the server may update the medical procedure database to indicate that the medical procedure barcode indicated in the redeem data has been redeemed and the medical service provider at which the redemption occurred (block 248).

Reliance upon a barcode as a preferably unique designator associated with each treatment tip eliminates the need to include hardware in the construction of the treatment tip for the purpose of limiting the amount of tip use. For example, the introduction of the barcode into the verification procedure may eliminate the need for integrating a memory chip, such as a programmable erasable programmable read only memory (EPROM), into each treatment tip. Among the benefits of eliminating the memory chip may be a reduction in the cost of treatment tips.

It will be understood that when an element is described as being “attached”, “connected”, or “coupled” to or with another element, it can be directly connected or coupled to the other element or, instead, one or more intervening elements may be present. In contrast, when an element is described as being “directly attached”, “directly connected”, or “directly coupled” to another element, there are no intervening elements present. When an element is described as being “indirectly attached”, “indirectly connected”, or “indirectly coupled” to another element, there is at least one intervening element present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “composed of”, “includes”, “having”, “has”, “with”, or variants thereof are used in either the detailed description or the claims, such terms are intended to be inclusive in a manner similar to the term “comprising.”

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. Thus, the invention in its broader aspects is therefore not limited to the specific details, representative apparatus and method, and illustrative example shown and described.

What is claimed is:

1. A method for performing a medical procedure with a medical device at a medical service provider, the method comprising:
receiving medical procedure barcode data associated with a medical procedure barcode at the medical device;
transmitting the medical procedure barcode data from the medical device over a communication network;
receiving validation data at the medical device from the communication network, where the validation data indicates if the medical procedure bar code is valid;
analyzing the validation data to determine whether the medical procedure barcode is valid;
in response to determining that the medical procedure barcode is valid, enabling operation of the medical device, thereby redeeming the medical procedure barcode at the medical service provider.

2. The method of claim 1, further comprising:
in response to redeeming the medical procedure barcode, transmitting data from the medical device over the communication network indicating that the medical procedure barcode was redeemed and indicating the medical service provider at which the medical procedure barcode was redeemed from the medical device over the communication network.

3. The method of claim 1, further comprising:
reading a medical procedure barcode using a barcode reader in communication with the medical device to generate medical procedure barcode data;
transmitting the medical procedure barcode data to the medical device; and
performing the medical procedure with the enabled medical device at the medical service provider.

4. The method of claim 3, wherein performing the medical procedure with the enabled medical device at the medical service provider comprises:
generating electromagnetic radiation for performing a dermatological or cosmetic tissue treatment as the medical procedure.

5. The method of claim 1, further comprising:
receiving the medical procedure barcode data from the medical device over the communication network;
generating a database query based at least in part on the medical procedure barcode data;
querying a medical procedure database with the database query;
receiving a query response from the medical procedure database, the query response indicating whether the medical procedure barcode associated with the medical procedure barcode data is valid;
generating validation data based at least in part on the query response; and
transmitting the validation data to the medical device over the communication network.

6. A method for collecting payment for a medical procedure utilizing a medical device, the method comprising:
receiving a medical procedure request from a communication network;
collecting a medical procedure payment based at least in part on the medical procedure request over the communication network; and
in response to collecting the medical procedure payment, generating a medical procedure barcode based at least in part on the medical procedure request, wherein the medical procedure barcode enables the medical device to perform the medical procedure when the medical procedure barcode is read by a barcode reader in communication with the medical device.

7. The method of claim 6, further comprising:
in response to generating the medical procedure barcode, updating a medical procedure database to indicate that the medical procedure barcode is valid.

8. The method of claim 7, further comprising:
receiving data indicating that the medical procedure barcode has been redeemed at a medical service provider; and
updating the medical procedure database to indicate that the medical procedure barcode has been redeemed and the medical service provider at which the medical procedure barcode was redeemed.

9. The method of claim 8, further comprising:
analyzing the medical procedure database to determine whether the medical procedure barcode has been redeemed; and
in response to determining that the medical procedure barcode has been redeemed, transmitting a medical service payment to the medical service provider.

10. A medical device configured to perform a medical procedure when the medical device is set to an enabled state, the medical device comprising:
a memory;
a transceiver configured to connect to a communication network;
a processor configured to:
receive medical procedure barcode data associated with a medical procedure barcode;
transmit the medical procedure barcode data over a connected communication network using the transceiver;
receive validation data indicating whether the medical procedure barcode is valid, from the connected communication network using the transceiver;
analyze the validation data to determine whether the medical procedure barcode associated with the medical procedure barcode data is valid;
in response to determining that the medical procedure barcode is valid, set the medical device to the enabled state, thereby enabling the medical device to perform the medical procedure.

11. The medical device of claim 10, wherein the processor is further configured to:
in response to setting the medical device to the enabled state, transmit data indicating that the medical procedure barcode has been redeemed and indicating a medical service provider at which the medical procedure barcode was redeemed over the connected communication netwrk using the transceiver.

12. The medical device of claim 10, further comprising:
a treatment tip; and
a handpiece configured to be removably coupled with the treatment tip.

13. The medical device of claim 12, further comprising:
a barcode reader configured to:
read a medical procedure barcode associated with the treatment tip;
generate medical procedure barcode data based on the medical procedure barcode; and
communicate the medical procedure barcode data to the processor of the medical device.

14. The medical device of claim 12, wherein the medical procedure barcode is affixed to the treatment tip coupled to the hand-piece.

15. The medical device of claim 12, wherein the medical device is configured to generate electromagnetic radiation for performing a dermatological or cosmetic tissue treatment as the medical procedure.
